(19) United States
(12) Patent Application Publication
(10) Pub. No.: US 2025/0348721 A1
(43) Pub. Date: Nov. 13, 2025

(54) ARTIFICIAL NEURON DEVICE IMPLEMENTING ASSOCIATIVE LEARNING AND LEARNING METHOD OF ARTIFICIAL NEURON DEVICE FOR IMPLEMENTING ASSOCIATIVE LEARNING

(71) Applicant: KOREA INSTITUTE OF SCIENCE AND TECHNOLOGY, Seoul (KR)

(72) Inventors: Suyoun LEE, Seoul (KR); Sangheon KIM, Seoul (KR)

(73) Assignee: KOREA INSTITUTE OF SCIENCE AND TECHNOLOGY, Seoul (KR)

(21) Appl. No.: 19/089,662

(22) Filed: Mar. 25, 2025

(30) Foreign Application Priority Data
May 8, 2024 (KR) 10-2024-0060696

(51) Int. Cl. G06N 3/063; G06N 3/044

(52) U.S. Cl. CPC G06N 3/063; G06N 3/044

(57) ABSTRACT

The disclosed introduces an artificial neuron device and system implementing associative learning that efficiently simulates brain-like learning, memory extinction, and spontaneous recovery processes using a simplified circuit structure incorporating a Conductive Bridge Memristor (CBM) and Threshold Switch (TS), significantly reducing computing resources and energy consumption in multimodal AI applications.

### CROSS-REFERENCE TO RELATED APPLICATIONS

This application claims the benefit of Korea Patent Application No. 10-2024-0060696 filed on May 8, 2024, which is incorporated herein by reference for all purposes as if fully set forth herein.

### TECHNICAL FIELD

The embodiments relate to an artificial neuron device implementing associative learning and a system for implementing associative learning.

### BACKGROUND

Organisms naturally perceive and associate various types of stimuli, which forms abilities essential for survival. Recently, this complex information processing capability has become increasingly important in artificial intelligence (AI) technology development due to its significant impact on various environments.

For example, utilizing Associative Multimodal Artificial Intelligence (AMAI) that applies complex information processing capabilities can greatly improve patient diagnosis and treatment in the biomedical field.

Additionally, when applying complex information processing capabilities to AI (Artificial Intelligence), it is expected to significantly enhance AI's predictive functions to prevent accidents and disasters. The latest version of Open AI's chatbot, GPT4, currently has multimodal capabilities, receiving image and text inputs and returning text output. Nevertheless, the development of multimodal AI remains challenging because associative learning (AL), a key element of multimodal AI, places a burden on computing and memory resources.

### PRIOR ART DOCUMENTS

### Patent Documents

(Patent Document 1) Korean Patent Publication No. 10-2020-0041768 (2020.04.22) “Artificial Neuron Device Using Ovonic Threshold Switch, Neural Chip Including the Same, and User Device”

### SUMMARY

The present invention is proposed to address such problems, and an objective of the embodiments is to provide an artificial neuron device and system that can implement associative learning including learning, memory extinction, and spontaneous memory recovery processes occurring in the brain using circuits with low complexity, thereby improving the energy and computing resource efficiency of current multimodal artificial intelligence technology.

According to one embodiment, an artificial neuron device implementing associative learning includes: a first resistor (R1) connected between a first input terminal (D1) and a first node (N1); a diode connected to the first node (N1) and connected to a CBM (Conductive Bridge Memristor) through a third node (N3) and a third resistor (R3); a first capacitor (C1) connected between the first node (N1) and ground; a second capacitor (C2) connected between the third resistor (R3) and ground; a second resistor (R2) connected to a second input terminal (D2) and connected to the CBM; and a Threshold Switch (TS) connected between the first node (N1) and a second node (N2) and generating spike current changes, wherein the CBM is connected to the second resistor (R2) through a top electrode (TE), and connected to the diode and the third resistor (R3) through a bottom electrode (BE).

Furthermore, an unconditional stimulus (US) may be input to the first input terminal, and a neutral stimulus (NS) may be input to the second input terminal.

Furthermore, the artificial neuron device may further include a load resistor (RL) connected to the threshold switch, and the first capacitor (C1), the threshold switch, and the load resistor (RL) constitute a soma, wherein the soma may always fire when the unconditional stimulus is input.

Furthermore, the CBM may be set to a high resistance state (HRS).

Furthermore, the CBM may change to a low resistance state (LRS) in a period (00 input period) where both the US and NS stimuli disappear after both the US and NS are simultaneously input (11 input period).

Furthermore, the process of the CBM changing from a high resistance state to a low resistance state may be a period where the artificial neuron device is learned.

Furthermore, after the learning occurs, the NS may change to a conditional stimulus (CS).

Furthermore, the artificial neuron device may include a memory extinction (extinction) period where the CS changes back to the NS when only the CS is repeatedly input without the US being input.

Furthermore, the artificial neuron device may exhibit a spontaneous recovery (SR) phenomenon where the NS changes back to the CS after a predetermined time (Tpause) has elapsed following the memory extinction period.

According to another embodiment, an associative learning system using multiple input stimuli includes: an unconditional stimulus (US) input module; a neutral stimulus (NS) input module; and a soma module (SOMA), wherein the CBM (Conductive Bridge Memristor) included in the neutral stimulus input module is set to a high resistance state (HRS) and changes to a low resistance state (Low Resistance State, LRS), whereby the system learns.

Furthermore, the CBM may change to a low resistance state (LRS) in a period (00 input period) where both the US and NS stimuli disappear after both stimuli are simultaneously input (11 input period) to the unconditional stimulus input module and the neutral stimulus input module.

Furthermore, after learning occurs, the neutral stimulus input module may change to a conditional stimulus (CS) input module.

Furthermore, the associative learning system may include a memory extinction period (extinction) where the conditional stimulus input module changes back to a neutral stimulus input module when only the CS is repeatedly input without the US being input.

Furthermore, the associative learning system may exhibit a spontaneous recovery (SR) phenomenon where the neutral stimulus input module changes back to the conditional stimulus input module after a predetermined time (Tpause) has elapsed following the memory extinction period.

The embodiments can contribute to implementing associative multimodal learning devices in artificial intelligence by implementing associative learning using a Threshold Switch (TS), CBM (Conductive Bridge Memristor), and several circuit elements.

Furthermore, the embodiments can contribute to implementing predictive AI systems.

### BRIEF DESCRIPTION OF THE DRAWINGS

The accompanying drawings, which are included to provide a further understanding of the present disclosure and constitute a part of the detailed description, illustrate embodiments of the present disclosure, and serve to explain technical features of the present disclosure together with the description.

(a) of FIG. 1 is a conceptual diagram illustrating a method of implementing associative learning for two types of input stimuli in existing artificial intelligence technology. (b) of FIG. 1 is a conceptual diagram illustrating a method of implementing associative learning for two types of stimuli using the associative learning neuron proposed in the embodiments.

FIG. 2 is a circuit diagram of the artificial neuron device, specifically the associative learning neuron device, according to the embodiments.

FIG. 3 shows input waveforms (VD1, VD2) and voltage waveforms at each node of the associative learning neuron device according to the embodiments shown in (b) of FIG. 1.

FIG. 4 is a graph for verifying the associative learning function of the associative learning neuron device according to the embodiments.

FIG. 5 is a graph for verifying the memory extinction and spontaneous memory recovery functions according to the embodiments.

(a) of FIG. 6 is a conceptual diagram of a neural network including multiple associative learning neuron devices and associative learning systems according to the embodiments. (b) of FIG. 6 is a conceptual diagram explaining an application example of a neural network including multiple associative learning neuron devices and associative learning systems according to the embodiments.

### DETAILED DESCRIPTION

In describing the embodiments of the present specification, if it is determined that a detailed description of related known technologies may unnecessarily obscure the essence of the present specification, the detailed description will be omitted. The terms used herein are defined considering their functions in the present specification and may vary according to the intention or convention of users or operators. Therefore, their definitions should be made based on the content throughout the present specification. The terms used in the detailed description are only for describing specific embodiments and are not intended to limit the present specification. Unless clearly used otherwise, expressions in the singular include the plural meaning. In this description, terms such as “include” or “comprise” are used to specify the presence of stated features, numbers, steps, operations, elements, parts, or combinations thereof, and do not preclude the presence or possibility of one or more other features, numbers, steps, operations, elements, parts, or combinations thereof.

Terms including ordinal numbers such as “first”, “second”, etc., can be used to describe various components, but the components are not limited by these terms. These terms are only used to distinguish one component from another component. For example, a first component could be termed a second component, and similarly, a second component could be termed a first component without departing from the scope of the present disclosure. The term “and/or” encompasses any and all combinations of words enumerated with this term.

The term “and/or” is used to include all possible combinations of its subject items. For example, “A and/or B” includes three cases: “A”, “B”, and “A and B”.

When one component is referred to as being “connected” or “coupled” to another component, it should be understood that the component may be directly connected or coupled to the other component, but there may also be another component present between them.

Hereinafter, specific embodiments of the present specification will be described with reference to the drawings. The following detailed description is provided to assist in a comprehensive understanding of the methods, apparatuses, and/or systems described herein. However, these are merely examples and the present specification is not limited thereto.

(a) of FIG. 1 is a conceptual diagram illustrating a method of implementing associative learning for two types of input stimuli in existing artificial intelligence technology. Existing artificial intelligence technology implements associative learning using a third neural network that processes signals processed by two neural networks composed of multiple layers for single-mode input processing.

(b) of FIG. 1 is a conceptual diagram illustrating a method of implementing associative learning for two types of stimuli using the associative learning neuron proposed in the embodiments.

Referring to (a) and (b) of FIG. 1, associative learning will be explained. In conventional DNN (Deep Neural Network)-based artificial intelligence systems, the approach shown in (a) of FIG. 1 was taken to learn relationships between heterogeneous input signals (e.g., images, sounds).

Specifically, in conventional artificial intelligence systems, there exists a DNN (10) that receives a first stimulus (e.g., lightning), and a separate DNN (10) that receives a second stimulus (e.g., thunder), and by inputting the outputs of each DNN (10) into a new DNN, the relationship between the first stimulus and the second stimulus was learned by the artificial intelligence system.

However, artificial intelligence systems like that shown in (a) of FIG. 1 require substantial computing resources and energy. Therefore, using an associative learning artificial neuron device that can directly receive and process associative learning for each type of input signal can reduce the computing resources and energy required for implementing associative learning.

(b) of FIG. 1 also shows an example of a multiple-input neuron layer (20). As shown in (b) of FIG. 1, using a multiple-input neuron layer (20) allows inputting multiple inputs (e.g., heterogeneous input signals) into a single multiple-input neuron layer (20) to teach the artificial intelligence system the relationship between the first stimulus and second stimulus. Therefore, using a multiple input neuron layer (20) as shown in (b) of FIG. 1 can reduce computing resources and energy required for implementing associative learning.

As another example of associative learning, Pavlov's dog can be mentioned. That is, when a dog is taught the relationship between an unconditional stimulus (US) (e.g., food) and a neutral stimulus (e.g., bell sound), the dog shows the same response when acquiring only the neutral stimulus (Neutral Stimulus, NS) as when acquiring the unconditional stimulus, and thus the neutral stimulus changes to a conditional stimulus (Conditional Stimulus, CS).

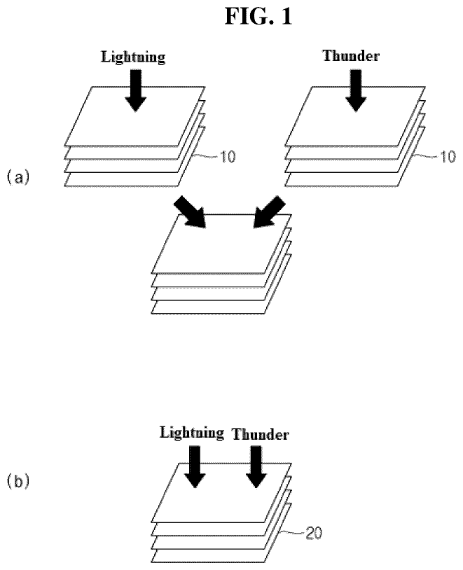

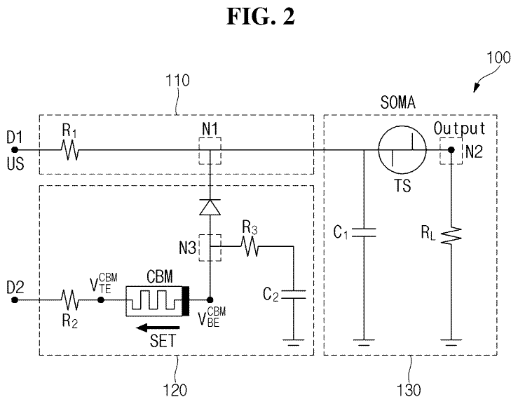

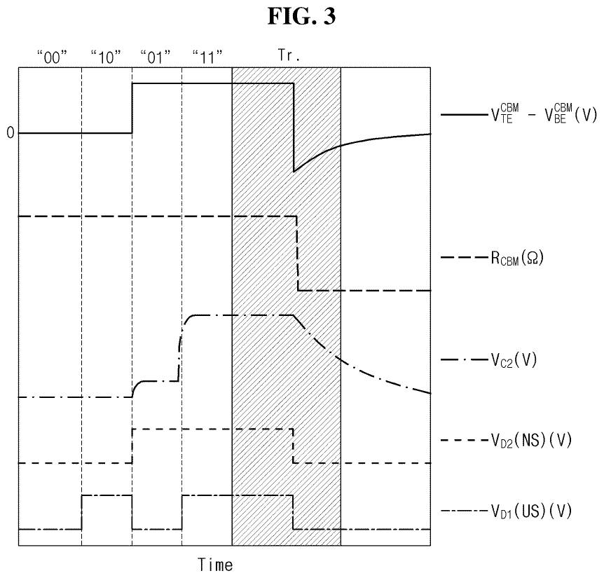

FIG. 2 is a circuit diagram of the artificial neuron device, specifically the associative learning neuron device according to the embodiments. FIG. 3 shows input waveforms (VD1, VD2) and voltage waveforms at each node of the associative learning neuron device shown in (b) of FIG. 1.

Referring to FIG. 2, the artificial neuron device (100) implementing associative learning includes a first resistor (R1) connected between a first input terminal (D1) and a first node (N1), a diode connected to the first node (N1) and connected to CBM (Conductive Bridge Memristor) through a third node (N3) and third resistor (R3), a first capacitor (C1) connected between the first node (N1) and ground, a second capacitor (C2) connected between the third resistor (R3) and ground, a second resistor (R2) connected to a second input terminal (D2) and connected to the CBM, and a threshold switch (TS) connected between the first node (N1) and second node (N2) that generates spike current changes.

The threshold switch (TS) generally refers to any device that exhibits threshold switching characteristics, wherein the device transitions from an insulating state to a conductive state when a voltage above a certain threshold is applied. One example is an Ovonic threshold switch, which is a device that uses specific amorphous chalcogenide materials as the switching material. Other types of threshold switches include devices that use Mott insulators (such as VO2, NbO2, etc.) as switching materials and devices that use Ag-doped SiO2. In the present invention, various types of threshold switches may be used without specific limitations.

In the embodiments, the CBM is connected to the second resistor (R2) through a top electrode (TE), and connected to the diode and the third resistor (R3) through a bottom electrode (BE).

The first input terminal (D1), first resistor (R1), and first node (N1) may constitute an unconditional stimulus input module (110).

The second input terminal (D2), second resistor (R2), second capacitor (C2), CBM, diode, and third resistor (R3) may initially constitute a neutral stimulus input module (120). The neutral stimulus input module (120) of the embodiments may later change to a conditional stimulus input module during circuit operation.

The first capacitor (C1), OTS, and RL constitute a soma module (130, SOMA).

For the second input terminal (D2) to function as a neutral stimulus input module (120), the CBM must have bipolar switching characteristics. This means that the CBM must maintain a constant resistance state while its bias polarity is not reversed. In the embodiments, the CBM may initially be set to a high resistance state (High Resistance State, HRS).

The associative learning system according to the embodiments may include an unconditional stimulus input module (110), a neutral stimulus input module (120), and a soma module (130).

Referring to FIG. 3, “00” input means neither unconditional stimulus nor neutral stimulus is input. “10” input means only unconditional stimulus is input. “01” input means only neutral stimulus is input. “11” input means both unconditional stimulus and neutral stimulus are input simultaneously. In FIG. 3, “Tr.” indicates the period where CBM transitions from a high resistance state to a low resistance state.

Referring to FIG. 3, the operation of the artificial neuron device (100) implementing associative learning and the associative learning system will be explained.

In the “00” input period and “10” input period where VD2=0, the soma module (130) is electrically separated from the neutral stimulus input module (120) due to the diode included in the neutral stimulus input module (120), therefore periods where VD2=0 are periods where the first input terminal (D1) operates as an unconditional stimulus input.

In the embodiments, when VD2 is applied (01 input or 11 input), because the CBM is set to maintain a high resistance state with bias polarity, the voltage drop of the second capacitor (C2) is relatively small. In the 01 input period or 11 input period, since the first input terminal (D1) acts as a sink, the soma module (130) does not fire.

However, when both VD1 and VD2 are applied (11 input period), since the first input terminal (D1) no longer acts as a sink, the voltage drop of the second capacitor (C2) becomes relatively large.

Subsequently, when both VD1 and VD2 are not input (00 input period), some charge stored in the second capacitor flows to the second input terminal (D2), thus as shown in FIG. 3, the CBM can be made to transition to a low resistance state (Low Resistance State, LRS) with polarity. Using the CBM in a low resistance state allows only the input from the second input terminal (D2) to trigger the firing of the soma module (130).

To implement this operating principle, in the embodiments, the OTS and CBM were fabricated to have nearly identical structures. The difference between the OTS and CBM structures is that the CBM has a thin layer of Ag inserted between the active layer (GeSe-based matrix) and the bottom electrode (Bottom Electrode, BE). This structural difference between OTS and CBM has the advantage of facilitating the fabrication process of the associative learning neuron presented in FIG. 2.

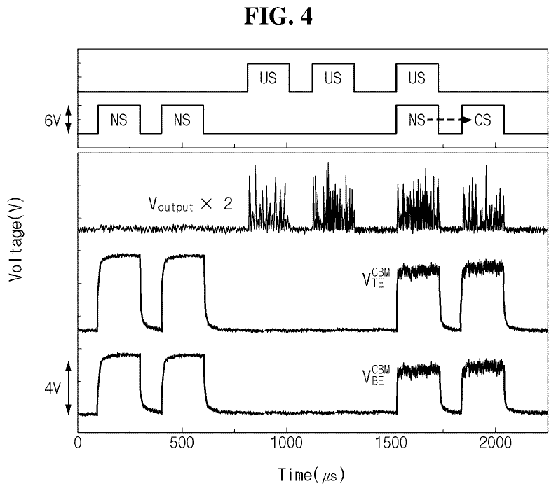

FIG. 4 is a graph for verifying the associative learning function of the associative learning neuron device according to the embodiments.

Referring to FIG. 4, initially \textcircled{1} during the 01 input period where only NS is input to the second input terminal (D2), no spike is observed in the response (Voutput) of the soma module (130). Subsequently, \textcircled{2} during the 10 input period where only US is input to the first input terminal (D1), spikes are observed in the response of the soma module (130).

Next, \textcircled{3} period is the associative learning period, where spikes are observed in the soma module (130) during the 11 input period when both US and NS are input. Subsequently, in \textcircled{4} period, spikes are observed in the soma module (130) with only 01 input, i.e., input from the second input terminal (D2).

In other words, in the associative learning neuron device according to the embodiments, after the associative learning period (11 input period), the NS input to the second input terminal (D2) performs the role of a conditional stimulus (Conditional Stimulus, CS). In other words, after the associative learning period (11 input period), it can be seen that NS has changed to CS.

The CBM that has changed to a low resistance state (Low Resistance State, LRS) can be restored to a high resistance state. That is, after the associative learning period, the CBM can change back to a high resistance state.

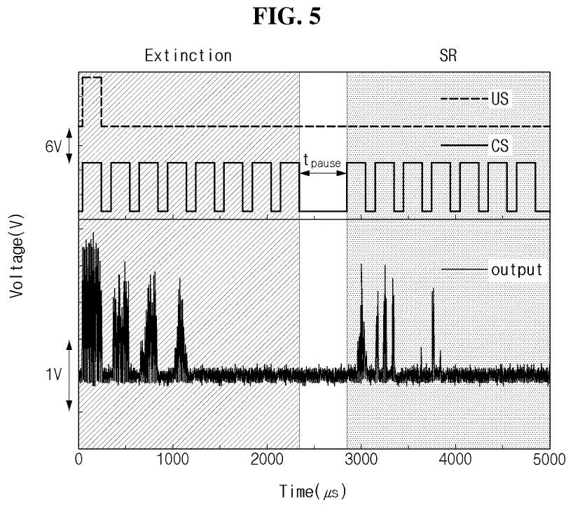

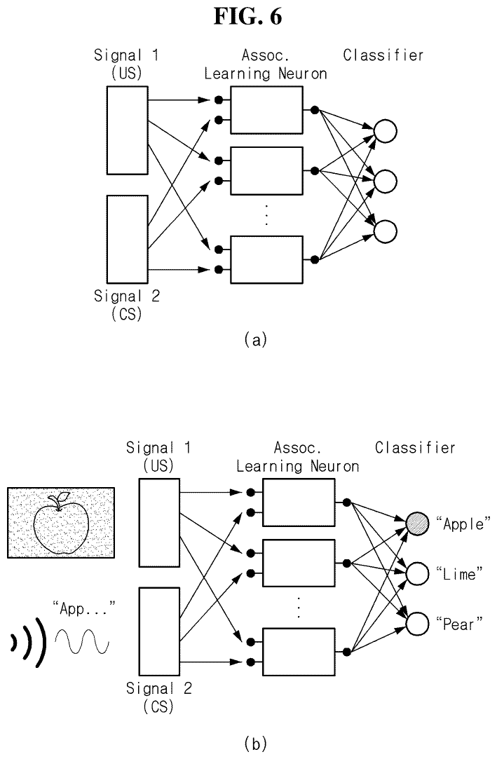

FIG. 5 is a graph for verifying the memory extinction and spontaneous memory recovery functions according to the embodiments.

The artificial neuron device (100) implementing associative learning and the associative learning system according to the embodiments can implement the memory extinction and spontaneous memory recovery processes of associative learning.

Referring to FIG. 5, after the learning period, when only the conditional stimulus CS is repeatedly input, it was observed that the spikes in the soma module (130) disappeared after a certain number of repetitions. This observation can correspond to how in Pavlov's dog experiment, the dog's response disappears when only the bell sound stimulus is continuously applied after the food & bell sound stimulus. Therefore, it can be seen that the artificial neuron device (100) implementing associative learning and the associative learning system according to the embodiments implement the memory extinction (extinction) process of associative learning.

In FIG. 5, after the memory extinction period and after a predetermined time (Tpause) has elapsed, when only CS stimulus is applied again, spikes in the soma module (130) are observed again. The predetermined time (Tpause) can be set to, for example, 500 μs. This observation can correspond to how in Pavlov's dog experiment, the memory of the relationship between food and bell sound was not completely erased, but rather a trace of the memory of food and bell sound remained.

Therefore, it can be seen that the artificial neuron device (100) implementing associative learning and the associative learning system according to the embodiments implement the spontaneous memory recovery (Spontaneous Recovery, SR) process of associative learning.

According to various embodiments of the artificial neuron device (100) implementing associative learning and the associative learning system described above, learning and memory extinction processes necessary for 100% implementation of associative learning can be implemented using circuits with low complexity.

The artificial neuron device (100) implementing associative learning and the associative learning system according to the embodiments have verified the spontaneous recovery (SR) phenomenon where NS changes back to CS after a predetermined time (Tpause) has elapsed following the memory extinction period.

Since associative learning is a process that can reduce the time required for re-programming and plays an important role in long-term memory formation, the embodiments can contribute to implementing associative multimodal learning devices in artificial intelligence and can contribute to implementing predictive AI systems.

(a) of FIG. 6 is a conceptual diagram of a neural network including multiple associative learning neuron devices and associative learning systems according to the embodiments. (b) of FIG. 6 is a conceptual diagram explaining an application example of a neural network including multiple associative learning neuron devices and associative learning systems according to the embodiments.

Referring to (a) of FIG. 6, according to one embodiment, the neural network may include an input device consisting of a sensor part that detects two or more signals and a processing part that pre-processes (pre-processing) the detected signals (e.g., US and CS).

Referring to (a) of FIG. 6, according to one embodiment, the neural network may include multiple artificial neuron devices (100) implementing associative learning and associative learning systems according to the embodiments. The portion containing multiple artificial neuron devices (100) implementing associative learning and associative learning systems may be referred to as Assoc. Learning Neuron may be termed as a learning processing layer.

According to one embodiment, the neural network may include a classifier that classifies inputs from the output of the learning processing layer, and a synapse array connecting the learning processing layer and the classifier.

Referring to (b) of FIG. 6, according to one embodiment, the neural network may receive an image signal (US) meaning “apple” as one signal, and receive an audio signal (CS) meaning “apple” as another signal and transmit them to the learning processing layer. The learning processing layer learns the relationship between US and CS, and can subsequently perform memory extinction and spontaneous memory recovery. For example, the neural network can determine correct results using audio signals as input based on the results of associative learning.

The description of the above-described embodiments of the present specification is provided for illustration only, and those skilled in the art can readily implement various modifications in other specific forms without changing the technical spirit or essential features of the present specification. Therefore, the embodiments described above should be considered in all respects as illustrative rather than limiting.

The scope of the present specification is indicated by the claims described below rather than the detailed description above, and all changes or modifications derived from the meaning and scope of the claims and their equivalents should be construed as being included in the scope of the present specification.

What is claimed is:

1. An artificial neuron device implementing associative learning, comprising:
a first resistor (R1) connected between a first input terminal (D1) and a first node (N1);
a diode connected to the first node (N1) and connected to a CBM (Conductive Bridge Memristor) through a third node (N3) and a third resistor (R3);
a first capacitor (C1) connected between the first node (N1) and ground;
a second capacitor (C2) connected between the third resistor (R3) and ground;
a second resistor (R2) connected to a second input terminal (D2) and connected to the CBM; and
a threshold switch (TS) connected between the first node (N1) and a second node (N2) and generating spike current changes,
wherein the CBM is connected to the second resistor (R2) through a top electrode (TE), and connected to the diode and the third resistor (R3) through a bottom electrode (BE).

2. The artificial neuron device of claim 1, wherein an unconditional stimulus (US) is input to the first input terminal, and a neutral stimulus (NS) is input to the second input terminal.

3. The artificial neuron device of claim 2, further comprising:
a load resistor (RL) connected to the threshold switch,
wherein the first capacitor (C1), the threshold switch, and the load resistor (RL) constitute a soma, and
wherein the soma always fires when the unconditional stimulus is input.

4. The artificial neuron device of claim 3, wherein the CBM is set to a high resistance state (HRS).

5. The artificial neuron device of claim 4, wherein the CBM changes to a low resistance state (LRS) in a period (00 input period) where both the US and NS stimuli disappear after both the US and NS are simultaneously input (11 input period).

6. The artificial neuron device of claim 5, wherein the process of the CBM changing from a high resistance state to a low resistance state is a period where the artificial neuron device is learned.

7. The artificial neuron device of claim 6, wherein after the learning occurs, the NS changes to a conditional stimulus (CS).

8. The artificial neuron device of claim 7, wherein the device includes a memory extinction (extinction) period where the CS changes back to the NS when only the CS is repeatedly input without the US being input.

9. The artificial neuron device of claim 8, wherein after the memory extinction period, the device exhibits spontaneous recovery (SR) phenomenon where the NS changes back to the CS after a predetermined time (Tpause) has elapsed.

10. An associative learning system using multiple input stimuli, comprising: an unconditional stimulus (US) input module; a neutral stimulus (NS) input module; and a soma module (SOMA), wherein a CBM (Conductive Bridge Memristor) is included in the neutral stimulus input module is set to a high resistance state (HRS) and changes to a low resistance state (Low Resistance State, LRS), whereby the system learns.

11. The associative learning system of claim 10, wherein the CBM changes to a low resistance state (LRS) in a period (00 input period) where both the US and NS stimuli disappear after both stimuli are simultaneously input (11 input period) to the unconditional stimulus input module and the neutral stimulus input module.

12. The associative learning system of claim 11, wherein after learning occurs, the neutral stimulus input module changes to a conditional stimulus (CS) input module.

13. The associative learning system of claim 12, wherein the system includes a memory extinction period (extinction) where the conditional stimulus input module changes back to a neutral stimulus input module when only the CS is repeatedly input without the US being input.

14. The associative learning system of claim 13, wherein after the memory extinction period. the system exhibits a spontaneous recovery (SR) phenomenon where the neutral stimulus input module changes back to the conditional stimulus input module after a predetermined time (Tpause) has elapsed.
